(19) United States
(12) Patent Application Publication
(10) Pub. No.: US 2020/0032090 A1
(43) Pub. Date: Jan. 30, 2020

(54) RECORDING METHOD

(71) Applicant: SEIKO EPSON CORPORATION, Tokyo (JP)

(72) Inventors: Hiroaki KUMETA, Matsumoto (JP); Ryosuke TERAMOTO, Matsumoto (JP); Tetsuya AOYAMA, Shiojiri (JP)

(73) Assignee: SEIKO EPSON CORPORATION, Tokyo (JP)

(21) Appl. No.: 16/498,239

(22) PCT Filed: Mar. 20, 2018
(86) PCT No.: PCT/JP2018/011212

§ 371 Date: Sep. 26, 2019

(30) Foreign Application Priority Data
Mar. 28, 2017 (JP) 2017-063290

(51) Int. Cl. C09D 11/38; C09D 11/326; B41M 5/52; B41J 2/21

(52) U.S. Cl. CPC C09D 11/38; B41J 2/2107; B41M 5/5227; C09D 11/326

(57) ABSTRACT

A recording method is provided that includes a step of making a record on a recording medium using an ink composition containing a colorant, an organic compound, and water to obtain a recording article. The amount (W1) of moisture in the recording article after one second from recording and the amount (W5) of moisture in the recording article after five seconds from recording satisfy the following relational formulas:

W1≤2.0 [mg/inch²] (1)

5.0[%]≤(W1−W5)×100/W1≤30[%] (2).

### CROSS-REFERENCE TO RELATED APPLICATION

The present application is based on, and claims priority from JP Application Serial Number 2017-063290, filed Mar. 28, 2017, the disclosure of which is hereby incorporated by reference herein in its entirety.

### BACKGROUND

### Technical Field

The present invention relates to a recording method.

### Related Art

An ink jet recording method can record a high-definition image with a relatively simple device and has evolved rapidly in various fields. In the meantime, various investigations have been made to obtain a high-quality recording article in a more stable way.

For example, Japanese Unexamined Patent Application Publication No. 2013-056489 discloses an ink jet recording method in which an aqueous ink with a viscosity of 15 mPa·s or more at 25° C. is used for high-speed printing in which the time taken from printing to paper ejection is ten seconds or less or for printing in which a method for transporting paper includes turning paper for the purpose of providing an ink jet recording method in which the occurrence of trouble due to curl is prevented even if printing conditions such as ink jet print speed, a transport path, the amount of applied ink, and the area coated with ink vary.

However, even if the ink jet recording method described in Patent Literature 1 is used, there is room for improvement in suppressing the curl of a recording article recorded using an ink composition containing water. In particular, in a case where a large number of records are made at high speed, making records on a recording medium using an ink composition containing enough water to maintain the excellent color developability of a recording article causes curl and internal transportability after recording and stackability after ejection are significantly poor.

Therefore, the present invention has been made to solve the above problem and has an object to provide a recording method which maintains the excellent color developability of a recording article and which is excellent in stackability after ejection even in a case where a large number of records are made at high speed using an ink composition containing water.

### SUMMARY

The inventors have performed intensive investigations to solve the above problem and, as a result, have found that using a recording method which includes a step of making a record on a recording medium using an ink composition containing a colorant, an organic compound, and water to obtain a recording article and in which the amount of moisture in the recording article after one second from recording and the amount of moisture in the recording article after five seconds from recording satisfy predetermined relational formulas maintains the excellent color developability of the recording article and is excellent in stackability after ejection even in a case where a large amount of records are made at high speed using the ink composition containing water, whereby the present invention has been completed.

That is, the present invention provides a recording method which includes a step of making a record on a recording medium using an ink composition containing a colorant, an organic compound, and water to obtain a recording article and in which the amount (W1) of moisture in the recording article after one second from recording and the amount (W5) of moisture in the recording article after five seconds from recording satisfy the following relational formulas:

W1≥2.0 [mg/inch²] (1)

5.0[%]≤(W1−W5)×100/W1≤30[%] (2).

A factor that the recording method according to the present invention can solve the above problem is probably as described below. However, the factor is not limited to this. That is, in a conventional recording method using an ink composition containing water, water contained in the ink composition penetrates a recording medium to cause swelling (for example, hydrogen bonds between cellulose fibers are broken) and, thereafter, water evaporates to reduce swelling (for example, hydrogen bonds are re-formed between the cellulose fibers), whereby the curl of a recording article is caused. However, in the recording method according to the present invention, mainly because the amount (W1) of moisture in the recording article after one second from recording satisfies Relational Formula (1), the recording article contains a sufficient amount of moisture and therefore the penetration of the ink composition through the recording medium is facilitated; hence, the ink composition is excellent in quick drying. Furthermore, since the colorant can be stably dispersed in the ink composition and dyes the recording medium without aggregation, the ink composition is free from unevenness and is excellent in color developability. In the recording medium according to the present invention, mainly because the amount (W1) of moisture in the recording article after one second from recording and the amount (W5) of moisture in the recording article after five seconds from recording satisfy Relational Formula (2), the rapid evaporation of water in the recording article is suppressed and the curl thereof is suppressed. The recording article, of which the curl is suppressed, is excellent in stackability after ejection.

In the recording method according to the present invention, it is preferable that the organic compound includes betaine and an unsaturated aliphatic acid and the mass ratio (betaine/unsaturated aliphatic acid) of the betaine to the unsaturated aliphatic acid is from 14 to 140, the content of the betaine is preferably 3.0% by mass to 7.0% by mass with respect to the total amount of the ink composition, the content of the unsaturated aliphatic acid is preferably 0.05% by mass to 0.3% by mass with respect to the total amount of the ink composition, the mass ratio (water/betaine) of the water to the betaine is preferably 8.0 or more, and the sum of the amounts of the betaine and the unsaturated aliphatic acid in the recording article is preferably 0.1 mg/inch² to 0.45 mg/inch².

Furthermore, in the recording method according to the present invention, the ink composition preferably further contains a solubilizer and the solubilizer preferably contains one or more selected from the group consisting of polyoxyethylene alkyl ethers, polyoxyethylene oleyl ether, and acetylene glycol.

Still furthermore, in the recording method according to the present invention, it is preferable that the rate of change in curl of the recording article after recording is represented by the following formula and the rate of change in curl of the recording article after one second from recording and the rate of change in curl of the recording article after five seconds from recording are both 40% or less:

rate of change in curl [%]=|curl angle (degrees) of recording after X seconds from recording/90 [degrees]|×100 (3)

(where the “curl angle” is the angle formed by the most curled end portion of the recording article and a point of contact between the recording article and a horizontal plane).

In addition, the present invention provides a recording article obtained by the recording method according to the present invention.

### BRIEF DESCRIPTION OF THE DRAWINGS

FIG. 1 is a schematic view illustrating a method for measuring the curl angle of a recording medium or a recording article in this embodiment.

FIG. 2 is a schematic view showing the image area used to evaluate the rubfastness of a recording article in an example.

### DETAILED DESCRIPTION

An embodiment (hereinafter referred to as “this embodiment”) of the present invention is described below in detail. This embodiment below is an example illustrative of the present invention and is not intended to limit the present invention to contents below. The present invention can be appropriately modified within the scope thereof.

### Recording Method

A recording method according to this embodiment includes a step of making a record on a recording medium using an ink composition containing a colorant, an organic compound, and water to obtain a recording article. In the recording method, the amount (W1) of moisture in the recording article after one second from recording and the amount (W5) of moisture in the recording article after five seconds from recording satisfy the following relational formulas:

W1≥2.0 [mg/inch²] (1)

5.0[%]≤(W1−W5)×100/W1≤30[%] (2).

The following factor is probably as described below: a factor that the recording method according to this embodiment maintains the excellent color developability of the recording article and is excellent in stackability after ejection even in a case where a large number of records are made at high speed using the ink composition, which contains water. However, the factor is not limited to this. That is, in a conventional recording method using an ink composition containing water, water contained in the ink composition penetrates a recording medium to causes swelling (for example, hydrogen bonds between cellulose fibers are broken) and, thereafter, water evaporates to reduce swelling (for example, hydrogen bonds are re-formed between the cellulose fibers), whereby the curl of a recording article is caused. However, in the recording method according to the present invention, mainly because the amount (W1) of moisture in the recording article after one second from recording satisfies Relational Formula (1), the recording article contains a sufficient amount of moisture and therefore the penetration of the ink composition through the recording medium is facilitated; hence, the recording medium is excellent in quick drying. Furthermore, since the colorant can be stably dispersed in the ink composition and dyes the recording medium without aggregation, the ink composition is free from unevenness and is excellent in color developability. In the recording method according to the present invention, mainly because the amount (W1) of moisture in the recording article after one second from recording and the amount (W5) of moisture in the recording article after five seconds from recording satisfy Relational Formula (2), the rapid evaporation of water in the recording article is suppressed and the curl thereof is suppressed. The recording article of which the curl is suppressed is excellent in stackability after ejection.

### Ink Composition

The ink composition according to this embodiment contains the colorant, the organic compound, and water.

### Colorant

The ink composition according to this embodiment contains the colorant. The colorant used may be at least one of pigment and dye.

In this embodiment, when the colorant used is pigment, the color developability of the ink composition can be enhanced. The pigment used may be any of an inorganic pigment and an organic pigment.

In order to apply the pigment to the ink composition, it is preferable that the pigment can be stably dispersed and held in water. Examples of a method therefor include a method in which the pigment is dispersed using a resin dispersant made of a water-soluble resin and/or a water-dispersible resin (the pigment dispersed by this method is hereinafter referred to as the resin-dispersed pigment), a method in which the pigment is dispersed using a water-soluble surfactant and/or a water-dispersible surfactant (the pigment dispersed by this method is hereinafter referred to as the surfactant-dispersed pigment), and a method in which a water-soluble group is chemically and physically grafted to the surface of the pigment such that the pigment can be dispersed and/or dissolved in water without any dispersant such as the resin or the surfactant (the pigment dispersed by this method is hereinafter referred to as the self-dispersible pigment). In this embodiment, the ink composition may contain any of the resin-dispersed pigment, the surfactant-dispersed pigment, and the self-dispersible pigment or may contain a mixture of a plurality of types as required.

In this embodiment, among the resin-dispersed pigment, the surfactant-dispersed pigment, and the self-dispersible pigment, the pigment, which is used in the ink composition, is preferably the self-dispersible pigment because the self-dispersible pigment is excellent in color developability.

The self-dispersible pigment is pigment that can be dispersed and/or dissolved in an aqueous medium without any dispersant as described above. The phrase “dispersed and/or dissolved in an aqueous medium without any dispersant” as used herein refers to a state in which pigment is stably present in an aqueous medium because of a surface water-soluble group thereof without using a dispersant to disperse pigment.

When the ink composition containing the self-dispersible pigment as a colorant, the ink composition need not contain a dispersant for the purpose of dispersing usual pigment, is substantially free from foaming due to the reduction of anti-foaming properties due to the dispersant, and is readily prepared so as to have excellent discharge stability. Since gas liquid dry contaminants due to the dispersant are suppressed, the ink composition is excellent in discharge reliability. Since the significant increase in viscosity due to the dispersant is suppressed, a larger amount of pigment can be contained, thereby enabling print density to be sufficiently enhanced.

In this embodiment, the self-dispersible pigment, which is used in the ink composition, is a self-dispersible pigment having a water-soluble group on the pigment surface and the water-soluble group is one or more water-soluble groups selected from the group consisting of —OM, —COOM, —CO—, —SO₃M, —SO₂M, —SO₂NH₂, —RSO₂M, —PO₃HM, —PO₃M₂, —SO₂NHCOR, —NH₃, and —NR₃ (where M represents a hydrogen atom, an alkali metal, an ammonium, or an organic ammonium and R represents a naphthyl group that may have an alkyl group or substituent containing one to 12 carbon atoms).

The self-dispersible pigment, which is used in the ink composition, is produced in such a manner that, for example, pigment is subjected to a physical treatment or a chemical treatment such that the water-soluble group is bonded (grafted) to the surface of the pigment. The physical treatment is, for example, a vacuum plasma treatment or the like. The chemical treatment is, for example, a wet oxidation process in which oxidation is carried out in water using an oxidizing agent or the like. The specific surface area of a pigment dispersion can be adjusted in such a manner that the amount of the water-soluble group grafted to the pigment surface.

In this embodiment, the self-dispersible pigment is preferably a self-dispersible pigment surface-treated by oxidation using a hypohalous acid and/or a hypohalite, oxidation using ozone, or oxidation using persulfuric acid and/or a persulfate from the viewpoint of high color development.

The inorganic pigment used may be carbon black (C.I. Pigment Black 7) such as furnace black, lamp black, acetylene black, or channel black; iron oxide; or titanium oxide.

Examples of the organic pigment include azo pigments such as insoluble azo pigments, condensed azo pigments, azo lakes, and chelate azo pigments; polycyclic pigments such as phthalocyanine pigments, perylene, perinone pigments, anthraquinone pigments, quinacridone pigments, dioxane pigments, thioindigo pigments, isoindoline pigments, and quinophthalone pigments; dye chelates (for example, basic dye chelates and acidic dye chelates); dyeing lakes (basic dye lakes and acidic dye lakes); nitro pigments; nitroso pigments; aniline black; and daylight fluorescent pigments.

In more particular, examples of carbon black used as a black ink include No. 2300, No. 900, MCF88, No. 33, No. 40, No. 45, No. 52, MA7, MA8, MA100, No. 2200B (the above being produced by Mitsubishi Chemical Corporation), Raven 5750, Raven 5250, Raven 5000, Raven 3500, Raven 1255, Raven 700 the above being produced by Columbian Carbon Company), Regal 400R, Regal 330R, Regal 660R, Mogul L, Monarch 700, Monarch 800, Monarch 880, Monarch 900, Monarch 1000, Monarch 1100, Monarch 1300, Monarch 1400 (produced by Cabot Corporation), Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (the above being produced by Degussa AG).

Examples of pigment used in a white ink include C.I. Pigment Whites 6, 18, and 21.

Examples of pigment used in a yellow ink include C.I. Pigment Yellows 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, and 180.

Examples of pigment used in a magenta ink include C.I. Pigment Reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178 179, 184, 185, 187, 202, 209, 219, 224, and 245 and C.I. Pigment Violets 19, 23, 32, 33, 36, 38, 43, and 50.

Examples of pigment used in a cyan ink include C.I. Pigment Blues 1, 2, 3, 15, 15:1, 15:2, 15:3, 15:34, 15:4, 16, 18, 22, 25, 60, 65, and 66 and C.I. Vat Blues 4 and 60.

Examples of pigment other than magenta, cyan, and yellow include C.I. Pigment Greens 7 and 10; C.I. Pigment Browns 3, 5, 25, and 26; and C.I. Pigment Oranges 1, 2, 5, 7, 13, 14, 15, 16, 24, 34, 36, 38, 40, 43, and 63.

Examples of dye include acidic dyes, direct dyes, reactive dyes, and basic dyes. In particular, the following dyes are cited: C.I. Acid Yellows 17, 23, 42, 44, 79, and 142; C.I. Acid Reds 52, 80, 82, 249, 254, and 289; C.I. Acid Blues 9, 45, and 249; C.I. Acid Blacks 1, 2, 24, and 94; C.I. Food Blacks 1 and 2; C.I. Direct Yellows 1, 12, 24, 33, 50, 55, 58, 86, 132, 142, 144, and 173; C.I. Direct Reds 1, 4, 9, 80, 81, 225, and 227; C.I. Direct Blues 1, 2, 15, 71, 86, 87, 98, 165, 199, and 202; C.I. Direct Blacks 19, 38, 51, 71, 154, 168, 171, and 195; C.I. Reactive Reds 14, 32, 55, 79, and 249; and C.I. Reactive Blacks 3, 4, and 35.

The colorant may be used alone or in combination with one or more colorants. The content of the colorant is preferably 0.1% by mass to 20% by mass with respect to the total amount (100% by mass) of the ink composition, more preferably 1.0% by mass to 15% by mass, and further more preferably 3.0% by mass to 10% by mass. When the content of the colorant is within the above range, the color developability of the recording article tends to be better.

In this embodiment, from the viewpoint of the discharge stability of the ink composition, the average particle size (D50) of pigment is preferably within the range of 5 nm to 400 nm, more preferably within the range of 30 nm to 300 nm, and further more preferably within the range of 50 nm to 200 nm.

In the present specification, the term “average particle size” refers to the volume-based average particle size unless otherwise specified. The average particle size can be measured with a particle size distribution analyzer using a laser diffraction/scattering method as a measurement principle. A laser diffraction particle size distribution analyzer used may be, for example, “Microtrac Series” (manufactured by MicrotracBEL Corp.).

### Organic Compound

The ink composition according to this embodiment contains an organic compound. The organic compound preferably includes at least one of betaine and an unsaturated aliphatic acid and more preferably includes betaine and the unsaturated aliphatic acid. In the present specification, the term “betaine” refers to a compound which can have a positive charge and a negative charge at positions not next to each other in a single molecule and which, in this case, has no charge as the whole molecule.

In this embodiment, when the organic compound includes betaine, it is easy to control a range satisfying above-mentioned Relational Formula (2) because betaine holds moisture in the recording article.

Betaine is not particularly limited and may be a compound containing a cationic group and an anionic group in a single molecule. Examples of betaine include quaternary amines such as trimethylglycine and carnitine, tertiary amines such as dimethylglycine, secondary amines, and amino acids such as glycine. In particular, one or more selected from the group consisting of trimethylglycine, dimethylglycine, and glycine is more preferable. When such betaine is used, sensitivity to disturbance such as the contamination of electrified contaminants tends to increase.

The number of carbon atoms in betaine is preferably 3 to 12, more preferably 3 to 7, and further more preferably 4 to 6. When the number of carbon atoms in betaine is within the above range, sensitivity to disturbance such as the contamination of electrified contaminants tends to increase.

Betaine may be used alone or in combination with one or more betaines. The content of betaine is preferably 1.0% by mass to 10% by mass with respect to the total amount (100% by mass) of the ink composition, more preferably 3.0% by mass to 7.0% by mass, and further more preferably 4.0% by mass to 6.0% by mass. When the content of betaine is 1.0% by mass or more, stackability tends to be better. When the content of betaine is 10% by mass or less, drying properties of the recording article tend to be good and the fixability thereof tends to be excellent.

In this embodiment, when the organic compound includes the unsaturated aliphatic acid, it is easy to control a range satisfying above-mentioned Relational Formula (2) because the unsaturated aliphatic acid facilitates the penetration and diffusion of moisture in the recording article and facilitates drying.

The unsaturated aliphatic acid is not particularly limited and may be an aliphatic acid containing a carbon-carbon double bond. Examples of the unsaturated aliphatic acid include a mono-unsaturated aliphatic acid containing a carbon-carbon double bond and a poly-unsaturated aliphatic acid containing two or more carbon-carbon double bonds. Examples of the mono-unsaturated aliphatic acid include, but are not limited to, crotonic acid, myristoleic acid, palmitoleic acid, oleic acid, elaidic acid, vaccenic acid, gadoleic acid, eicosenoic acid, erucic acid, and nervonic acid. Examples of the poly-unsaturated aliphatic acid include linoleic acid and linolenic acid.

The unsaturated aliphatic acid may be a purified one or natural oil such as olive oil, which mainly contains oleic acid.

The unsaturated aliphatic acid may be used alone or in combination with one or more unsaturated aliphatic acids. The content of the unsaturated aliphatic acid is preferably 0.01% by mass to 1.0% by mass with respect to the total amount (100% by mass) of the ink composition, more preferably 0.05% by mass to 0.3% by mass, and further more preferably 0.07% by mass to 0.2% by mass. When the content of betaine is 0.01% by mass or more, drying properties of the recording article tend to be good and the fixability thereof tends to be excellent. When the content of betaine is 1.0% by mass or less, the stackability tends to be better.

When the organic compound includes betaine and the unsaturated aliphatic acid, the mass ratio (betaine/unsaturated aliphatic acid) of betaine to the unsaturated aliphatic acid is preferably from 14 to 140, more preferably from 20 to 110, further more preferably from 25 to 90, and still further more preferably from 30 to 70. When mass ratio thereof is 14 or more, the stackability and high-temperature printing stability of the recording article tend to be better. When mass ratio thereof is 140 or less, the rubfastness tends to be better.

The organic compound may be used alone or in combination with one or more organic compounds. The content of the organic compound is preferably 0.1% by mass to 20% by mass with respect to the total amount (100% by mass) of the ink composition, more preferably 1.0% by mass to 15% by mass, and further more preferably 3.0% by mass to 10% by mass. When the content of betaine is 0.1% by mass or more, the color developability of the recording article tends to be better. When the content of betaine is 20% by mass or less, the dispersion of the colorant in the ink composition tends to be good.

### Solubilizer

The ink composition preferably further contains a solubilizer. The term “solubilizer” refers to one that facilitates the dissolution of the organic compound in the ink composition, particularly in water. When the ink composition contains the solubilizer, the precipitation of the organic compound in the ink composition tends to be suppressed and the homogeneous dispersion of the organic compound in the recording article tends to be facilitated. The solubilizer is not particularly limited and acts efficiently on the unsaturated aliphatic acid.

Examples of the solubilizer include, but are not limited to, an acetylene glycol solubilizer, an alkyl ether solubilizer, a fluorinated solubilizer, and a silicone solubilizer.

The acetylene glycol solubilizer is not particularly limited and is preferably one or more selected from 2,4,7,9-tetramethyl-5-decyne-4,7-diol, alkylene oxide adducts of 2,4,7,9-tetramethyl-5-decyne-4,7-diol, 2,4-dimethyl-5-decyne-4-ol, and alkylene oxide adducts of 2,4-dimethyl-5-decyne-4-ol. Commercially available products of the acetylene glycol solubilizer include, but are not limited to, for example, Olfine E1010, PD-002W, PD-005, EXP 4200, EXP 4300, WE-003, Surfynol 104E, 104PG50, 420, 465, 485, 61, 82, DF110D, DF37, DF75, MD-20, and the like (trade names, produced by Nissin Chemical Industry Co., Ltd.). The acetylene glycol solubilizer may be used alone or in combination with one or more acetylene glycol solubilizers.

The alkyl ether solubilizer is not particularly limited and is preferably one or more selected from polyoxyethylene 2-ethylhexyl ether, polyoxyethylene oleyl ether, polyoxyethylene tridecyl ether, polyoxyethylene castor oil ether, polyoxyethylene cetyl ether, polyoxyethylene stearyl ether, polyoxyethylene alkyl ethers, and polyoxyalkylene tridecyl ethers. Commercially available products of the alkyl ether solubilizer include, but are not limited to, for example, Newcol 1006, 1008, 1020 (trade names, produced by Nippon Nyukazai Co., Ltd.), Noigen DL-0415, ET-116B, ET-106A, DH-0300, YX-400, EA-160 (trade names, produced by Dai-ichi Kogyo Seiyaku Co., Ltd.), Emulgen 430, and 1108 (trade names, produced by Kao Corporation). The alkyl ether solubilizer may be used alone or in combination with one or more alkyl ether solubilizers.

Examples of the fluorinated solubilizer include, but are not limited to, perfluoroalkylsulfonates, perfluoroalkylcarboxylates, perfluoroalkylphosphoric acid esters, perfluoroalkyl-ethylene oxide adducts, perfluoroalkylbetaines, and perfluoroalkylamine oxide compounds. Commercially available products of the fluorinated solubilizer include, but are not limited to, for example, S-144, S-145 (the above being trade names, produced by AGC Inc.), FC-170C, FC-430, Fluorad-FC4430 (the above being trade names, produced by Sumitomo 3M Limited), FSO, FSO-100, FSN, FSN-100, FS-300 (the above being trade names, produced by DuPont Inc.), FT-250, and 251 (the above being trade names, produced by NEOS Company Limited). The fluorinated solubilizer may be used alone or in combination with one or more fluorinated solubilizers.

Examples of the silicone solubilizer include, but are not limited to, polysiloxane compounds and polyether-modified organosiloxanes. In particular, commercially available products of the silicone solubilizer include, but are not limited to, SAG 503A (trade name, produced by Nissin Chemical Industry Co., Ltd.), BYK-306, BYK-307, BYK-333, BYK-341, BYK-345, BYK-346, BYK-347, BYK-348, BYK-349 (the above being trade names, produced by Byk Chemie Japan K.K.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 ((the above being trade names, produced by Shin-Etsu Chemical Co., Ltd.). The silicone solubilizer may be used alone or in combination with one or more silicone solubilizers.

Among those described above, the solubilizer preferably contains the alkyl ether solubilizer or the acetylene glycol solubilizer and more preferably contains one or more selected from the group consisting of polyoxyethylene alkyl ethers, polyoxyethylene oleyl ether, and the acetylene glycol solubilizer.

The content of the solubilizer is preferably 0.05% by mass to 2.5% by mass with respect to the total amount (100% by mass) of the ink composition, more preferably 0.1% by mass to 1.5% by mass, and further more preferably 0.3% by mass to 1.0% by mass. When the content of the solubilizer is within the above range, the stackability, the rubfastness, and the high-temperature printing stability tend to be more excellent.

### Solvent

The ink composition according to this embodiment may further contain a solvent. The solvent is not particularly limited and may be used together with water.

The type of the solvent is not particularly limited. Examples of the solvent include aprotic polar solvents, monoalcohols, alkyl polyols, and glycol ethers. The solvent according to this embodiment can be appropriately selected from these organic solvents.

Examples of the aprotic polar solvents include, but are not limited to, 2-pyrrolidone, N-alkyl-2-pyrrolidones, 1-alkyl-2-pyrrolidones, γ-butyrolactone, 1,3-dimethyl-2-imidazolidinone, dimethyl sulfoxide, imidazole, 1-methylimidazole, 2-methylimidazole, and 1,2-dimethylimidazole.

Examples of the monoalcohols include, but are not limited to, methanol, ethanol, n-propyl alcohol, iso-propyl alcohol, n-butanol, 2-butanol, tert-butanol, iso-butanol, n-pentanol, 2-pentanol, 3-pentanol, and tert-pentanol.

Examples of the alkyl polyols include, but are not limited to, glycerin, ethylene glycol, diethylene glycol, triethylene glycol, propylene glycol (1,2-propanediol), dipropylene glycol, 1,3-propylene glycol (1,3-propanediol), isobutylene glycol (2-methyl-1,2-propanediol), 1,2-butanediol, 1,3-butanediol, 1,4-butanediol, 2-butene-1,4-diol, 1,2-pentanediol, 1,5-pentanediol, 2-methyl-2,4-pentanediol, 1,2-hexanediol, 1,6-hexanediol, 2-ethyl-1,3-hexanediol, 1,7-heptanediol, 1,8-octanediol, and trimethylolpropane.

Examples of the glycol ethers include, but are not limited to, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol monobutyl ether, diethylene glycol mono-t-butyl ether, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether.

The solvent may be used alone or in combination with one or more solvents. The content of the solvent is preferably 1.0% by mass to 70% by mass with respect to the total amount (100% by mass) of the ink composition, more preferably 5.0% by mass to 50% by mass, and further more preferably 10% by mass to 30% by mass. When the content of the solvent is within the above range, the stackability, the rubfastness, and the high-temperature printing stability tend to be more excellent.

### Water

The ink composition according to this embodiment contains water. Examples of water include those, such as pure water including ion-exchanged water, ultrafiltered water, reverse osmosis-purified water, and distilled water and ultrapure water, obtained by removing ionic impurities to the utmost. Using water sterilized by ultraviolet irradiation or the addition of hydrogen peroxide enables the growth of mold or bacteria to be prevented in a case where an aggregation liquid is stored for a long period. This tends to allow the storage stability to further increase.

The content of water is preferably 10% by mass to 90% by mass with respect to the total amount (100% by mass) of the ink composition, more preferably 40% by mass to 70% by mass, and further more preferably 50% by mass to 69% by mass. When the content of water is within the above range, the stackability, the rubfastness, and the color developability tend to be more excellent.

When the content of water is within the above range, the mass ratio (water/betaine) of water to betaine is preferably 8.0 or more, more preferably from 10 to 15, and further more preferably from 12 to 14. When the mass ratio thereof is within the above range, the balance between two functions, excellent color developability and excellent stackability, tends to be more excellent.

### Others

The ink composition may appropriately contain various additives such as resin particles, a dissolution aid, a viscosity modifier, a pH adjustor such as potassium hydroxide or triethanolamine, an oxidation inhibitor, an antimildew-antiseptic agent, a fungicide, a rust preventive, a chelating agent (for example, ethylenediaminetetraacetic acid) for capturing metal ions affecting dispersion as other components.

The resin particles have the effect of increasing the fixation of an image portion of the recording article because, as the ink composition dries, the resin particles are fused together and the resin particles and a coloring component are fused together to fix pigment to the recording medium; hence, the image fastness of the obtained recording tends to increase. The resin particles may be contained in the ink composition in the form of emulsion.

Herein, the term “emulsion” refers to one obtained by dispersing a resin component, sparingly soluble or insoluble in a liquid medium of the ink composition, in the liquid medium of the ink composition in the form of fine particles.

When the resin particles are contained in the ink composition in the form of emulsion, the viscosity of the ink composition is readily adjusted in an appropriate range in an ink jet recording method and the storage stability and discharge stability of the ink composition tend to be excellent.

Examples of resin include, but are not limited to, (meth)acrylic resins, styrene-acrylic resins, fluorene resins, urethanic resins, polyolefinic resins, rosin-modified resins, terpene resins, polyester resins, polyamide resins, epoxy resins, vinyl chloride resins, vinyl chloride-vinyl acetate copolymers, and ethylene-vinyl acetate resins. These resins may be used alone or in combination. These resins may be used in the form of homopolymers or copolymers. In this embodiment, the styrene-acrylic resins, the fluorene resins, the urethanic resins, and the polyolefinic resins are preferable from the viewpoint of increasing the rubfastness.

### Recording Step

The recording method according to this embodiment includes the step (hereinafter referred to as the recording step) of making the record on the recording medium using the above-mentioned ink composition to obtain the recording article. In the recording step, the ink composition is discharged onto the recording medium by, in particular, an ink jet process, whereby the recording article is obtained. The recording medium is, for example, an absorbent recording medium or a non-absorbent recording medium. The recording method according to this embodiment can be widely applied to recording media ranging from non-absorbent recording media that a water-soluble ink composition hardly penetrates to absorbent recording media that a water-soluble ink composition readily penetrates and is preferably applied to the absorbent recording media.

In particular, examples of the absorbent recording media include plain paper such as electronic photo paper with high ink permeability; ink jet paper (ink jet exclusive paper including an ink-absorbing layer made of silica particles or alumina particles or an ink-absorbing layer made of a hydrophilic polymer such as polyvinyl alcohol (PVA) or polyvinylpyrrolidone (PVP)); art paper, used for general offset printing, having relatively low ink permeability; coated paper; and cast paper.

In particular, examples of the non-absorbent recording media include films and plates of plastics such as polyvinyl chloride, polyethylene, polypropylene, and polyethylene terephthalate (PET) and also include plates of metals such as iron, silver, copper, and aluminium; metal plates manufactured by the vapor deposition of the metals; films made of plastics; and plates of alloys such as stainless steel and brass.

This embodiment may further includes a heating step of heating the recording medium in a portion or the whole before recording, during recording, and after recording for the purpose of facilitating the drying of ink. A heating means is not particularly limited and may be a device capable of controlling the temperature. Examples of the heating means include radiation heating-type sheath heaters, infrared heaters, contact heating-type sheet heaters, and methods using electromagnetic waves. The heating temperature is preferably 40° C. to 80° C. as the surface temperature of the recording medium. The recording method may further include a blowing step with a fan or the like.

The recording method according to this embodiment may include a known step included in a conventional ink jet recording method.

### Recording Article

The recording article according to this embodiment is not particularly limited and may be one obtained by the above-mentioned recording method.

In this embodiment, the amount (W1) of moisture in the recording article after one second from recording and the amount (W5) of moisture in the recording article after five seconds from recording satisfy the following relational formulas:

W1≥2.0 [mg/inch²] (1)

5.0[%]≤(W1−W5)×100/W1≤30[%] (2).

Since Relational Formula (1) is satisfied, a sufficient amount of moisture is present in the recording article, the ink composition is excellent in quick drying because the penetration of the ink composition through the recording medium is facilitated, and the colorant can be stably dispersed in the ink composition and dyes the recording medium without aggregation; hence, excellent color developability with no unevenness can be obtained. From the viewpoint of obtaining more excellent quick drying properties and color developability, W1 is preferably 2.3 [mg/inch²] or more, more preferably 2.7 [mg/inch²] or more, and further more preferably 3.0 [mg/inch²] or more.

Since Relational Formula (2) is satisfied, the stackability after ejection is excellent. From the viewpoint of obtaining more excellent stackability, (W1−W5)×100/W1 (hereinafter also referred to as the “rate of change in amount of moisture”) is preferably 7.0% to 25%, more preferably 10% to 23%, and further more preferably 13% to 20%.

The sum of the amounts of betaine and the unsaturated aliphatic acid in the recording article is preferably 0.01 mg/inch² to 1.0 mg/inch², more preferably 0.1 mg/inch² to 0.45 mg/inch², and further more preferably 0.2 mg/inch² to 0.3 mg/inch². When the sum of the amounts thereof is within the above range, the balance between two functions, excellent color developability and excellent stackability, tends to be more excellent. The sum of the amounts thereof is calculated from the amount of the ink composition applied to the recording medium and the composition of the ink composition.

The rate of change in curl of the recording article is defined as an indicator for the degree of curl of the recording article as represented by Formula (3) below. Herein, the rate of change in curl of the recording article after one second from recording and the rate of change in curl of the recording article after five seconds from recording are preferably both 40% or less, more preferably both 30% or less, and further more preferably both 20% or less. When the rate of change in curl thereof is within the above range, the stackability is tends to more excellent.

Rate of change in curl [%]=|curl angle (degrees) of recording after X seconds from recording/90 [degrees]|×100 (3)

(where the “curl angle” is the angle formed by the most curled end portion of the recording article and a point of contact between the recording article and the horizontal plane).

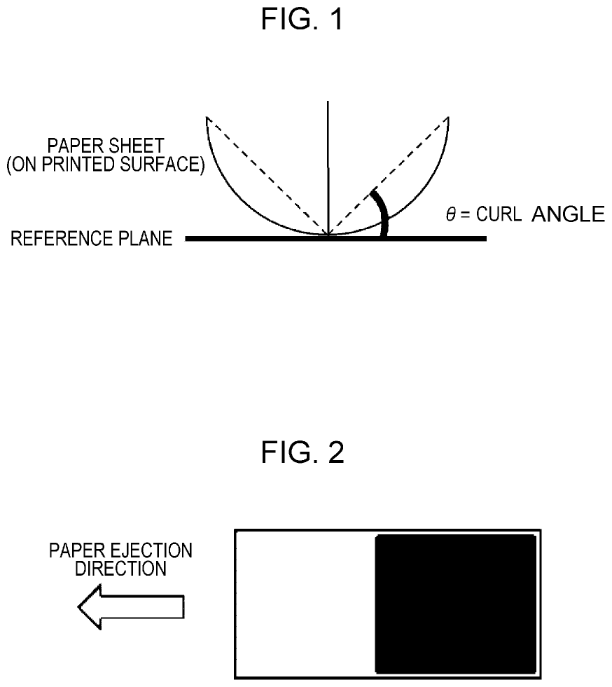

In the formula, the “curl angle” is an angle measured in a case where the recording medium or the recording article is placed on a flat plane or in a case where the recording medium or the recording article is hung in such a manner that an axis passing through the centroid of the recording medium or the recording article is fixed. FIG. 1 is a schematic view illustrating a method for measuring the curl angle of the recording medium or the recording article. As shown in FIG. 1, the recording medium or the recording article is placed on a predetermined place serving as a reference plane and the angle formed by an end portion of the recording medium or the recording article and a point of contact with the reference plane is measured, whereby the curl angle is determined. In particular, the curl angle is measured by a method described in an example below. In the case where the recording medium or the recording article is hung, which is not shown, a horizontal plane including the axis passing through the centroid thereof is used as a reference plane and the angle formed by the most curled end portion of the recording medium or the recording article and a point of contact between the recording medium or the recording article and the reference plane (horizontal plane) is measured, whereby the curl angle is determined. Herein, the term “point of contact” refers to a point at which a plane where the recording medium or the recording article is in contact with the horizontal plane crosses the axis passing through the centroid of the recording medium or the recording article.

The recording step is preferably performed in a line mode in which a record is made on the recording medium in a single scan using a recording head having a length greater than or equal to the width of the recording medium. The line mode enables printing at higher speed as compared to a multipath mode using a plurality of scans. Since the recording head, which has a length greater than or equal to the width of the recording medium, is used, a single elongated recording head or a recording head unit in which a plurality of recording heads are arranged can be used. In the recording step, one or more different recording heads are preferably used depending on color.

### EXAMPLES

This embodiment is further described below in detail with reference to examples and comparative examples. This embodiment is not in any way limited by the examples and comparative examples below unless this embodiment departs from the scope thereof.

In the examples and comparative examples below, materials used in ink compositions are as described below.

### Colorant

Cab-O-JET 300 (self-dispersible carbon black, a trade name of Cabot Corporation)

### Organic Compounds

Betaines
Trimethylglycine
Dimethylglycine
Glycine
Carnitine

Unsaturated Aliphatic Acids
Oleic acid
Linoleic acid
Linolenic acid

Solubilizers
Newcol 1006 (a trade name of Nippon Nyukazai Co., Ltd., polyoxyethylene-2-ethylhexyl ether (C₈H₁₇—O—(CH₂CH₂O)ₙ—H))
Emulgen 430 (a trade name of Kao Corporation, polyoxyethylene oleyl ether)
Surfynol 104 (a trade name of Nissin Chemical Industry Co., Ltd.)

Solvents
Glycerin (produced by Tokyo Chemical Industry Co., Ltd.)
Triethylene glycol monobutyl ether (produced by Tokyo Chemical Industry Co., Ltd.)

pH Adjustor
Potassium hydroxide

Resin Particles
Styrene-acrylic acid copolymer (“Mowinyl 6730”, a trade name of The Nippon Synthetic Chemical Industry Co., Ltd.)

Water
Pure water

### Preparation of Ink Compositions

Materials were mixed so as to give a composition shown in Tables 1 and 2 below and were sufficiently agitated, whereby compositions were obtained. Incidentally, values in Tables 1 and 2 represent the amount of solid matter, are in mass percent, and total 100.0% by mass.

TABLE 1

| Ink composition | | 1 | 2 | 3 | 4 | 5 | 6 | 7 | 8 | 9 |
|---|---|---|---|---|---|---|---|---|---|---|
| Colorant | Carbon black | 7.00 | 7.00 | 7.00 | 7.00 | 7.00 | 7.00 | 7.00 | 7.00 | 7.00 |
| Betaine | Trimethylglycine | 5.00 | — | — | — | 5.00 | 5.00 | 5.00 | 5.00 | 7.00 |
| | Dimethylglycine | — | 5.00 | — | — | — | — | — | — | — |
| | Glycine | — | — | 5.00 | — | — | — | — | — | — |
| | Carnitine | — | — | — | 5.00 | — | — | — | — | — |
| Unsaturated | Oleic acid | 0.10 | 0.10 | 0.10 | 0.10 | — | — | 0.10 | 0.10 | 0.05 |
| aliphatic | Linoleic acid | — | — | — | — | 0.10 | — | — | — | — |
| acid | Linolenic acid | — | — | — | — | — | 0.10 | — | — | — |
| Solubilizer | Newcol 1006 | 0.50 | 0.50 | 0.50 | 0.50 | 0.50 | 0.50 | — | — | 0.50 |
| | Emulgen 430 | — | — | — | — | — | — | 0.50 | — | — |
| | Surfynol 104 | — | — | — | — | — | — | — | 0.50 | — |
| Solvent | Glycerin | 15.30 | 15.30 | 15.30 | 15.30 | 15.30 | 15.30 | 15.30 | 15.30 | 13.35 |
| | Triethylene | 2.00 | 2.00 | 2.00 | 2.00 | 2.00 | 2.00 | 2.00 | 2.00 | 2.00 |
| | glycol | | | | | | | | | |
| | monobutyl | | | | | | | | | |
| | ether | | | | | | | | | |
| pH adjustor | Potassium | 0.10 | 0.10 | 0.10 | 0.10 | 0.10 | 0.10 | 0.10 | 0.10 | 0.10 |
| | hydroxide | | | | | | | | | |
| resin | Styrene- | 2.00 | 2.00 | 2.00 | 2.00 | 2.00 | 2.00 | 2.00 | 2.00 | 2.00 |
| particles | acrylic acid | | | | | | | | | |
| | copolymer | | | | | | | | | |
| | (Mowinyl 6730) | | | | | | | | | |
| Water | Pure water | 68.00 | 68.00 | 68.00 | 68.00 | 68.00 | 68.00 | 68.00 | 68.00 | 68.00 |

TABLE 2

| Ink composition | | 10 | 11 | 12 | 13 | 14 | 15 | 16 | 17 | 18 |
|---|---|---|---|---|---|---|---|---|---|---|
| Colorant | Carbon black | 7.00 | 7.00 | 7.00 | 7.00 | 7.00 | 7.00 | 7.00 | 7.00 | 7.00 |
| Betaine | Trimethylglycine | 3.00 | 3.00 | 7.00 | 5.00 | 5.00 | 5.00 | 5.00 | 5.00 | 5.00 |
| | Dimethylglycine | — | — | — | — | — | — | — | — | — |
| | Glycine | — | — | — | — | — | — | — | — | — |
| | Carnitine | — | — | — | — | — | — | — | — | — |
| Unsaturated | Oleic acid | 0.20 | 0.10 | 0.10 | 0.05 | 0.30 | 0.10 | 0.10 | 0.19 | 0.40 |
| aliphatic | Linoleic acid | — | — | — | — | — | — | — | — | — |
| acid | Linolenic acid | — | — | — | — | — | — | — | — | — |
| Solubilizer | Newcol 1006 | 0.50 | 0.50 | 0.50 | 0.50 | 0.50 | 0.50 | — | 0.50 | 0.50 |
| | Emulgen 430 | — | — | — | — | — | — | — | — | — |
| | Surfynol 104 | — | — | — | — | — | — | — | — | — |
| Solvent | Glycerin | 17.20 | 17.30 | 13.30 | 15.35 | 15.10 | 43.30 | 15.80 | 15.00 | 15.00 |
| | Triethylene | 2.00 | 2.00 | 2.00 | 2.00 | 2.00 | 2.00 | 2.00 | 2.00 | 2.00 |
| | glycol | | | | | | | | | |
| | monobutyl | | | | | | | | | |
| | ether | | | | | | | | | |
| pH adjustor | Potassium | 0.10 | 0.10 | 0.10 | 0.10 | 0.10 | 0.10 | 0.10 | 0.10 | 0.10 |
| | hydroxide | | | | | | | | | |
| resin | Styrene- | 2.00 | 2.00 | 2.00 | 2.00 | 2.00 | 2.00 | 2.00 | 2.00 | 2.00 |
| particles | acrylic acid | | | | | | | | | |
| | copolymer | | | | | | | | | |
| | (Mowinyl 6730) | | | | | | | | | |
| Water | Pure water | 68.00 | 68.00 | 68.00 | 68.00 | 68.00 | 40.00 | 68.00 | 68.00 | 68.00 |

### Amount of Moisture in Recording Articles

An ink jet recording apparatus used for evaluation below was an ink jet printer, PX-7050 (manufactured by Seiko Epson Corporation), that was modified such that a resolution of 600 dpi×600 dpi could be printed in a single scan (one path) and the printing speed was adjusted by adjusting the transportation speed of paper. An ink cartridge of the ink jet recording apparatus was filled with each ink jet composition and a solid pattern was printed on A4-size Xerox P paper (copy paper produced by Fuji Xerox Co., Ltd., a basis weight of 64 g/m², a thickness of 88 μm, a recording medium) in such a manner that the amount of applied ink was adjusted as shown in Tables 3 and 4 below. Incidentally, the printing speed was 100 sheets per minute.

Thereafter, the amount (W1) of moisture in an ejected recording article after one second from recording and the amount (W5) of moisture in the ejected recording article after five seconds from recording were measured and the rate of change in amount of moisture represented by the following equation was calculated:

rate of change in amount of moisture [%]=(W1−W5)×100/W1.

Herein, after the mass (P0) of the unprinted recording medium was measured using “MT400” (a trade name of Mettler Toledo K.K.) and a solid pattern was printed on the recording medium under the above conditions, the mass (P1) of the ejected recording article after one second from recording and the mass (P5) thereof after five seconds from recording were measured and the amount (W1) of moisture and the amount (W5) of moisture were calculated in accordance with the following equation:

amount of moisture=(mass of recording article after X seconds from recording−mass of recording medium)×(content of water in ink composition used [mass percent]).

Herein, the “amount of applied ink composition” in Tables 3 and 4 were adjusted by varying the duty using the following equation:

amount of applied ink composition [mg/inch²]=600×600 (two-dimensional resolution per inch)×14 [ng] (mass per dot)×10⁻⁶/print duty [%].

Herein, the print duty is represented by print duty [%]=(number of recording dots per square inch/two-dimensional resolution per inch 600×600)×100.

The “sum of amounts of betaine and unsaturated aliphatic acid in recording article”, “amount of betaine in recording article”, and “amount of unsaturated aliphatic acid in recording article” in Tables 3 and 4 were calculated from the composition ratio of an ink composition and the amount of the applied ink composition.

### Rate of Change in Curl

The above ink jet recording apparatus was used, an ink cartridge of the ink jet recording apparatus was filled with each ink jet composition, and a solid pattern was printed on A4-size Xerox P paper (copy paper produced by Fuji Xerox Co., Ltd., a basis weight of 64 g/m², a thickness of 88 μm, a recording medium) in an environment with a temperature of 25° C. and a relative humidity of 50% in a plain paper standard mode under pattern conditions below. Incidentally, the printing speed was 100 sheets per minute.

Pattern conditions: margin=1 mm, image area=whole of recording medium

Thereafter, an ejected recording article was mounted on the top surface of a cuboid box with a width of 1 cm, a length of 15 cm, and a height of 30 cm and the angle (unit: degrees) formed by the tip of paper and a point of contact with a reference plane (horizontal plane) was measured after one second from recording (curl angle (θ1) [degrees]) and after five seconds from recording (curl angle (θ5) [degrees]) with the position of the top surface of the box being assumed as 0. The rate of change in curl represented by the following equation was calculated from the measured angle:

rate of change in curl [%]=|curl angle of recording article after X seconds from recording (θx) [degrees]/90 [degrees]|×100 (3).

As shown in FIG. 1, the recording medium or the recording article was placed on a predetermined place serving as a reference plane and the angle θ formed by the most curled end portion of the recording medium or the recording article and a point of contact between the recording medium or the recording article and the reference plane (horizontal plane) was measured, whereby the curl angle of the recording medium or the recording article was determined. Incidentally, when the unprinted recording medium initially had a warp due to the weight thereof or the like, as with the above-mentioned method, the unprinted recording medium was mounted on the top surface of the cuboid box, the angle (curl angle (θ0) [degrees]) formed by the most curled end portion of the recording medium and a point of contact with the reference plane was measured, and the rate of change in curl was calculated by subtracting the angle formed thereby from the curl angle (θx) [degrees] of the recording article after X seconds from recording. In particular, Equation 3 was transformed into |(θx−θ0)/90|×100 and the rate of change in curl was calculated.

### Stackability

The above ink jet recording apparatus was used, an ink cartridge of the ink jet recording apparatus was filled with each ink jet composition, and a solid pattern was continuously printed on 200 sheets of A4-size Xerox P paper (copy paper produced by Fuji Xerox Co., Ltd., a basis weight of 64 g/m², a thickness of 88 μm, a recording medium) in an environment with a temperature of 25° C. and a relative humidity of 50% in a plain paper standard mode under pattern conditions below. Incidentally, the printing speed was 100 sheets per minute.

Pattern conditions: print duty=60% to 100%, margin width=1 mm, image area=whole of recording medium

After printing, the continuously printed 200 sheets that could be stored in an ejection section of the ink jet recording apparatus without being scattered were measured for print duty and were evaluated for stackability in accordance with evaluation standards below.

### Evaluation Standards

AA: A print duty of 90% or more

A: A print duty of 80% to less than 90%

B: A print duty of 70% to less than 80%

C: A print duty of less than 70%

### Rubfastness

The above ink jet recording apparatus was used, an ink cartridge of the ink jet recording apparatus was filled with each ink jet composition, and a solid pattern was continuously printed on 200 sheets of A4-size Xerox P paper (copy paper produced by Fuji Xerox Co., Ltd., a basis weight of 64 g/m², a thickness of 88 μm, a recording medium) in an environment with a temperature of 25° C. and a relative humidity of 50% in a plain paper standard mode under pattern conditions below. Incidentally, the printing speed was 100 sheets per minute.

Pattern conditions: print duty=100%, margin width=1 mm, image area=half of recording medium (FIG. 2)

FIG. 2 is a schematic view showing the image area used to evaluate the rubfastness of a recording article. The solid pattern was printed on a latter half portion along a paper ejection direction. After one second from the ejection of the recording article, a print portion (latter half portion) was rubbed with a finger, the extent of peeling of the ink composition was visually checked, and the rubfastness was evaluated in accordance with evaluation standards below.

### Evaluation Standards

AA: None of scratches and ink peeling is observed.

A: A scratch is observed and no ink peeling observed.

B: A scratch and ink peeling are observed and are inconspicuous.

C: A scratch and ink peeling are observed and are conspicuous.

### High-Temperature Printing Stability

The above ink jet recording apparatus was used, an ink cartridge of the ink jet recording apparatus was filled with each ink jet composition, and a one-dot rule pattern was printed on A4-size Xerox P paper (copy paper produced by Fuji Xerox Co., Ltd., a basis weight of 64 g/m², a thickness of 88 μm, a recording medium). Thereafter, a head discharging the ink composition was left for one hour in an environment with a temperature of 40° C. and a relative humidity of 20% without being capped, followed by similarly printing the one-dot rule pattern again.

After printing, the misalignment between rules of the recording article before and after leaving in the above environment was measured and the high-temperature printing stability was evaluated in accordance with evaluation standards below.

### Evaluation Standards

AA: A misalignment of less than 20 μm

A: A misalignment of 20 μm to less than 40 μm

B: A misalignment of 40 μm to less than 60 μm

C: A misalignment of 60 μm or more

### Color Developability

The above ink jet recording apparatus was used, an ink cartridge of the ink jet recording apparatus was filled with each ink jet composition, and a solid pattern was printed on A4-size Xerox P paper (copy paper produced by Fuji Xerox Co., Ltd., a basis weight of 64 g/m², a thickness of 88 μm, a recording medium) in an environment with a temperature of 25° C. and a relative humidity of 50% at a print duty of 80%. Incidentally, the printing speed was 100 sheets per minute.

After printing, the OD value was measured with a colorimeter (the trade name “Xrite i1”, manufactured by Xrite Inc.) and the color developability was evaluated in accordance with evaluation standards below.

### Evaluation Standards

AA: An OD value of 1.3 or more

A: An OD value of 1.2 to less than 1.3

B: An OD value of 1.1 to less than 1.2

C: An OD value of less than 1.1

TABLE 3

| | Exam- | Exam- | Exam- | Exam- | Exam- | Exam- | Exam- | Exam- | Exam- | Exam- | Exam- |
|---|---|---|---|---|---|---|---|---|---|---|---|
| | ple | ple | ple | ple | ple | ple | ple | ple | ple | ple | ple |
| | 1 | 2 | 3 | 4 | 5 | 6 | 7 | 8 | 9 | 10 | 11 |
| Ink composition | 1 | 1 | 1 | 2 | 3 | 4 | 5 | 6 | 7 | 8 | 9 |
| Amount of ink composition | 5.0 | 3.5 | 5.3 | 5.0 | 5.0 | 5.0 | 5.0 | 5.0 | 5.0 | 5.0 | 5.0 |
| applied to recording | | | | | | | | | | | |
| medium (mg/inch²) | | | | | | | | | | | |
| Amount of water after | 3.4 | 2.4 | 3.6 | 3.4 | 3.4 | 3.4 | 3.4 | 3.4 | 3.4 | 3.4 | 3.4 |
| one second from recording | | | | | | | | | | | |
| (mg/inch²) = W1 | | | | | | | | | | | |
| Amount of water after | 2.8 | 1.7 | 3.4 | 2.8 | 2.8 | 2.8 | 2.8 | 2.8 | 2.8 | 2.8 | 3.2 |
| five seconds from recording | | | | | | | | | | | |
| (mg/inch²) = W5 | | | | | | | | | | | |
| Rate of change in amount of | 17.0 | 30.0 | 5.0 | 17.0 | 17.0 | 17.0 | 17.0 | 17.0 | 17.0 | 17.0 | 5.0 |
| water after five seconds | | | | | | | | | | | |
| from recording (%) = | | | | | | | | | | | |
| (W1 − W5)/W1 | | | | | | | | | | | |
| Mass ratio of betaine/ | 50.0 | 50.0 | 50.0 | 50.0 | 50.0 | 50.0 | 50.0 | 50.0 | 50.0 | 50.0 | 140.0 |
| unsaturated aliphatic | | | | | | | | | | | |
| acid in ink composition | | | | | | | | | | | |
| Mass ratio of water/ | 13.6 | 13.6 | 13.6 | 13.6 | 13.6 | 13.6 | 13.6 | 13.6 | 13.6 | 13.6 | 9.7 |
| betaine in ink composition | | | | | | | | | | | |
| Sum of amounts of | 0.255 | 0.179 | 0.270 | 0.255 | 0.255 | 0.255 | 0.255 | 0.255 | 0.255 | 0.255 | 0.353 |
| betaine and unsaturated | | | | | | | | | | | |
| aliphatic acid in | | | | | | | | | | | |
| recording article | | | | | | | | | | | |
| (mg/inch²) | | | | | | | | | | | |
| Amount of betaine in | 0.250 | 0.175 | 0.265 | 0.250 | 0.250 | 0.250 | 0.250 | 0.250 | 0.250 | 0.250 | 0.350 |
| recording article | | | | | | | | | | | |
| (mg/inch²) | | | | | | | | | | | |
| Amount of unsaturated | 0.005 | 0.004 | 0.005 | 0.005 | 0.005 | 0.005 | 0.005 | 0.005 | 0.005 | 0.005 | 0.003 |
| aliphatic acid in | | | | | | | | | | | |
| recording article | | | | | | | | | | | |
| (mg/inch²) | | | | | | | | | | | |
| Rate of change in | 15 | 21 | 20 | 15 | 15 | 15 | 15 | 15 | 15 | 15 | 21 |
| curl after one second | | | | | | | | | | | |
| from recording (%) | | | | | | | | | | | |
| Rate of change in | 17 | 21 | 22 | 17 | 17 | 17 | 17 | 17 | 17 | 17 | 21 |
| curl after five seconds | | | | | | | | | | | |
| from recording (%) | | | | | | | | | | | |
| Stackability | AA | A | A | AA | AA | AA | AA | AA | AA | AA | A |
| Rubfastness | AA | AA | A | AA | AA | AA | AA | AA | AA | AA | B |
| High-temperature | AA | AA | AA | AA | AA | AA | AA | AA | AA | AA | A |
| printing stability | | | | | | | | | | | |
| Color developability | AA | A | AA | AA | AA | AA | AA | AA | AA | AA | AA |

TABLE 4

| | Exam- | Exam- | Exam- | Exam- | Exam- | Exam- | Exam- | Exam- | Compar- | Compar- | Compar- |
|---|---|---|---|---|---|---|---|---|---|---|---|
| | ple | ple | ple | ple | ple | ple | ple | ple | ative | ative | ative |
| | 12 | 13 | 14 | 15 | 16 | 17 | 18 | 19 | Example 1 | Example 2 | Example 3 |
| Ink composition | 10 | 11 | 12 | 13 | 14 | 15 | 16 | 17 | 1 | 1 | 18 |
| Amount of ink composition | 5.0 | 5.0 | 5.0 | 5.0 | 5.0 | 5.0 | 5.0 | 5.0 | 2.9 | 6.3 | 5.0 |
| applied to recording | | | | | | | | | | | |
| medium (mg/inch²) | | | | | | | | | | | |
| Amount of water after | 3.4 | 3.4 | 3.4 | 3.4 | 3.4 | 2 | 3.4 | 3.4 | 1.5 | 4.3 | 3.4 |
| one second from recording | | | | | | | | | | | |
| (mg/inch²) = W1 | | | | | | | | | | | |
| Amount of water after | 2.4 | 2.4 | 3.2 | 2.8 | 2.8 | 1.9 | 2.8 | 2.8 | 1.3 | 4.1 | 2.2 |
| five seconds from recording | | | | | | | | | | | |
| (mg/inch²) = W5 | | | | | | | | | | | |
| Rate of change in amount of | 30.0 | 30.0 | 5.0 | 17.0 | 17.0 | 5.0 | 17.0 | 17.0 | 13.0 | 4.0 | 36.0 |
| water after five seconds | | | | | | | | | | | |
| from recording (%) = | | | | | | | | | | | |
| (W1 − W5)/W1 | | | | | | | | | | | |
| Mass ratio of betaine/ | 14.0 | 30.0 | 70.0 | 100.0 | 16.7 | 50.0 | 50.0 | 26.3 | 50.0 | 50.0 | 12.5 |
| unsaturated aliphatic | | | | | | | | | | | |
| acid in ink composition | | | | | | | | | | | |
| Mass ratio of water/ | 22.7 | 22.7 | 9.7 | 13.6 | 13.6 | 8.0 | 13.6 | 13.6 | 13.6 | 13.6 | 13.6 |
| betaine in ink composition | | | | | | | | | | | |
| Sum of amounts of | 0.160 | 0.155 | 0.355 | 0.253 | 0.265 | 0.255 | 0.255 | 0.260 | 0.148 | 0.321 | 0.260 |
| betaine and unsaturated | | | | | | | | | | | |
| aliphatic acid in | | | | | | | | | | | |
| recording article | | | | | | | | | | | |
| (mg/inch²) | | | | | | | | | | | |
| Amount of betaine in | 0.150 | 0.150 | 0.350 | 0.250 | 0.250 | 0.250 | 0.250 | 0.250 | 0.145 | 0.315 | 0.250 |
| recording article | | | | | | | | | | | |
| (mg/inch²) | | | | | | | | | | | |
| Amount of unsaturated | 0.010 | 0.005 | 0.005 | 0.003 | 0.015 | 0.005 | 0.005 | 0.010 | 0.003 | 0.006 | 0.010 |
| aliphatic acid in | | | | | | | | | | | |
| recording article | | | | | | | | | | | |
| (mg/inch²) | | | | | | | | | | | |
| Rate of change in | 37 | 29 | 18 | 20 | 20 | 15 | 15 | 29 | 45 | 45 | 39 |
| curl after one second | | | | | | | | | | | |
| from recording (%) | | | | | | | | | | | |
| Rate of change in | 36 | 29 | 17 | 21 | 20 | 17 | 17 | 28 | 43 | 43 | 41 |
| curl after five seconds | | | | | | | | | | | |
| from recording (%) | | | | | | | | | | | |
| Stackability | B | A | AA | A | A | AA | A | AA | AA | C | C |
| Rubfastness | A | A | A | AA | A | B | AA | AA | AA | C | B |
| High-temperature | B | A | AA | AA | B | A | B | AA | AA | AA | C |
| printing stability | | | | | | | | | | | |
| Color developability | AA | AA | AA | AA | AA | AA | AA | AA | C | AA | AA |

1. A recording method comprising:
a step of making a record on a recording medium using an ink composition containing a colorant, an organic compound, and water to obtain a recording article, wherein the amount (W1) of moisture in the recording article after one second from recording and the amount (W5) of moisture in the recording article after five seconds from recording satisfy the following relational formulas:
W1≥2.0 [mg/inch²] (1)
5.0[%]≤(W1−W5)×100/W1≤30[%] (2).

2. The recording method according to claim 1,
wherein the organic compound includes betaine and an unsaturated aliphatic acid and
the mass ratio of the betaine to the unsaturated aliphatic acid is from 14 to 140.

3. The recording method according to claim 2,
wherein the content of the betaine is 3.0% by mass to 7.0% by mass with respect to the total amount of the ink composition.

4. The recording method according to claim 2,
wherein the content of the unsaturated aliphatic acid is 0.05% by mass to 0.3% by mass with respect to the total amount of the ink composition.

5. The recording method according to claim 2,
wherein the mass ratio of the water to the betaine is 8.0 or more.

6. The recording method according to claim 2,
wherein the sum of the amounts of the betaine and the unsaturated aliphatic acid in the recording article is 0.1 mg/inch² to 0.45 mg/inch².

7. The recording method according to claim 1,
wherein the ink composition further contains a solubilizer.

8. The recording method according to claim 7,
wherein the solubilizer contains one or more selected from the group consisting of polyoxyethylene alkyl ethers, polyoxyethylene oleyl ether, and acetylene glycol.

9. The recording method according to claim 1,
wherein the rate of change in curl of the recording article after recording is represented by the following formula and
the rate of change in curl of the recording article after one second from recording and the rate of change in curl of the recording article after five seconds from recording are both 40% or less:
rate of change in curl [%]=|curl angle (degrees) of recording after X seconds from recording/90 [degrees]|×100 (3)
(where the “curl angle” is the angle formed by the most curled end portion of the recording article and a point of contact between the recording article and a horizontal plane).

10. The recording method according claim 1,
wherein the step of obtaining the recording article is performed in a line mode in which a record is made on the recording medium in a single scan using a head having a length greater than or equal to the width of the recording medium.
